(19) United States
(12) Patent Application Publication
(10) Pub. No.: US 2006/0109450 A1
(43) Pub. Date: May 25, 2006

(54) Laser distance measuring device

(76) Inventor: Yi Liu, Nanjing City (CN)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/272,397

(22) Filed: Nov. 10, 2005

(30) Foreign Application Priority Data
Nov. 19, 2004 (CN) 200410065787.6

(51) Int. Cl. G01C 3/08

(52) U.S. Cl. 356/4.03; 356/4.01

(57) ABSTRACT

A laser distance measuring device is provided for measuring distance to an object. The laser distance measuring device comprises a laser emitter, a collimator objective lens, a optoelectronic converter, a receiving objective lens, and a control and analysis system, wherein the collimator objective lens and the receiving objective lens are aligned along a common axis. The laser emitter is positioned at the focal point of the collimator objective lens on the optical axis, and the light receiving surface of the optoelectronic converter is positioned at the focal point of the receiving objective lens on the optical axis.

### CROSS-REFERENCE TO RELATED APPLICATIONS

This application claims priority to Chinese Application No. 200410065787.6, filed on Nov. 19, 2004.

### FEDERALLY SPONSORED RESEARCH OR DEVELOPMENT

Not applicable.

### TECHNICAL FIELD

The present application relates to a laser distance measurement device, and particularly to an improved optical system in a laser distance measurement device.

### BACKGROUND OF THE INVENTION

An early optical distance measuring device with only one objective lens for transmitting a laser beam as well as receiving a reflected laser beam from a measured object is known as shown in FIG. 1. The optical distance measuring device 11 comprises a light emitting element 110, a light receiving element 111, a light splitting reflector 112, an objective lens 113, and a signal processing system (not shown in FIG. 1). The reflector 112 has two reflected surfaces which are inclined with respect to the optical axis of the objective lens 113. The light emitting element 110 is arranged on one side of the reflector 112 so that the modulated light from the light emitting element 110 is reflected by one reflected surface toward and through the objective lens 113 to be refracted into a parallel light 114 toward an measured object 115 which is in the form of a corner tube. The light receiving element 111 is arranged on another side of the reflector 112. The reflected parallel light 116 passes through the objective lens 113 and is projected onto another one reflected surface to be reflected toward the light entry surface of the light receiving element 111. The signal processing system deals with the electrical signals according to the reflected beam to determine the measured distance. The device of this type is capable of detecting a distance range up to hundreds of meters. However, it is bulky for the light emitting element 110 and the light receiving element 111 to be arranged on opposite sides of the objective lens 113 with the result that it is inconvenient for the user to schlep, store, and move the device frequently during practical operation.

A distance measuring device with separate transmitting and receiving objective lenses for distance measurement to a natural rough surface is known from EP701702B1, published on Feb. 5, 1997, under the title “DEVICE FOR DISTANCE MEASUREMENT”. As shown in FIG. 2, a visible measuring beam from a semiconductor laser 120 is projected onto a collimator objective lens 121 to be collimated along the optical axis 1210 of the latter into a parallel measuring beam 122 which is then projected onto a measured object 126 in the form of natural rough surface to be scattered in all directions so that a part of the measuring beam is reflected to a receiving objective lens 124. The optical axis 1210 of the collimator objective lens 121 runs at least virtually parallel to the optical axis 1240 of the receiving objective lens 124. For far distance measurement, the object 126 appears to lie at infinity for the receiving optics 124 so that the reflected beam 123 appears to be a parallel beam along the optical axis 1240. Then the reflected beam 123 is converged at the focal point of the receiving objective lens 124. The light entry surface of the laser receiving device 125 arranged on the optical axis 1240 at the focus of the receiving optics 124 can therefore receive the converged point of the reflected beam 123 nicely. For short distance measurement, such as within 2 m, the converged point of the reflected beam 123 is increasingly remote from the focal point longitudinally and transversely to the optical axis 1240 of the receiving optics 124. The light entry surface arranged on the focal point then receives no more light. In one embodiment, a mechanism device is provided to enable the light entry surface of the laser receiving device 125 to track the displacement of the converged point position of the reflected beam 123, specially only transversely with respect to the optical axis 1240 of the receiving optics 124, as shown in dashed lines in FIG. 2. In other embodiments disclosed in EP701702B1, a planar mirror 128 as shown in FIG. 3, or a prism 129 as shown in FIG. 4, or other optical elements, are provided for deflecting the converged point of the reflected beam 123 back to the optical axis 1240 of the receiving optics 124. However, whether a mechanism device for moving the light entry surface or an optical element for deflecting the converged point of the reflected beam 123 is provided in the housing of a distance measuring device, it makes the optical system of the device complex, bulky and costly.

The present invention is provided to solve the problems discussed above and other problems, and to provide advantages and aspects not provided by prior laser distance measuring devices of this type. A full discussion of the features and advantages of the present invention is deferred to the following detailed description, which proceeds with reference to the accompanying drawings.

### SUMMARY OF THE INVENTION

The present invention is based on the object of providing a laser distance measuring device with simple optical structure and high measuring precision. This object is achieved by a laser distance measuring device according to the present invention.

According to the present invention, a laser distance measuring device comprises: a laser emitter for generating a laser beam. The generated laser beam is passed through a collimator objective lens and collimated along an optical axis. The device also includes an optoelectronic converter with a light receiving surface for receiving light signals and converting them into corresponding electrical signals. The device further includes a receiving objective lens for receiving and imaging a reflected beam from a measured object onto the light receiving surface of The optoelectronic converter. A control and analysis system is electrically connected to said laser emitter and said optoelectronic converter separately for providing a series of high-frequency signals for modulating said laser emitter, and analyzing said electrical signals output from said optoelectronic converter to evaluate the measured distance from the object. The collimator objective lens and the receiving objective lens are preferably aligned along a common axis, with the laser emitter lying on said common axis at the focal point of said collimator objective lens and the optoelectronic converter arranged so that said light receiving surface lies on said common axis at the focal point of said receiving objective lens.

In operation, a known length is measured via the internal reference path before and after an external length measurement to compensate for drift effects in the electronics and in the optoelectronic converter, resulting in improved precision of distance measurement.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a schematic drawing of optical system of an early optical distance measuring device;

FIGS. 2-4 are schematic drawings of optical system of a laser distance measuring device disclosed in EP701702B1;

FIG. 5 is a schematic drawing of a first preferred embodiment of the optical system of a laser distance measuring device provided in the present invention;

FIG. 6 is a schematic drawing of a second preferred embodiment of the optical system of a laser distance measuring device provided in the present invention;

FIG. 7 is a schematic drawing of a third preferred embodiment of the optical system of a laser distance measuring device provided in the present invention;

FIG. 8 is a sectional view along line B-B in FIG. 7.

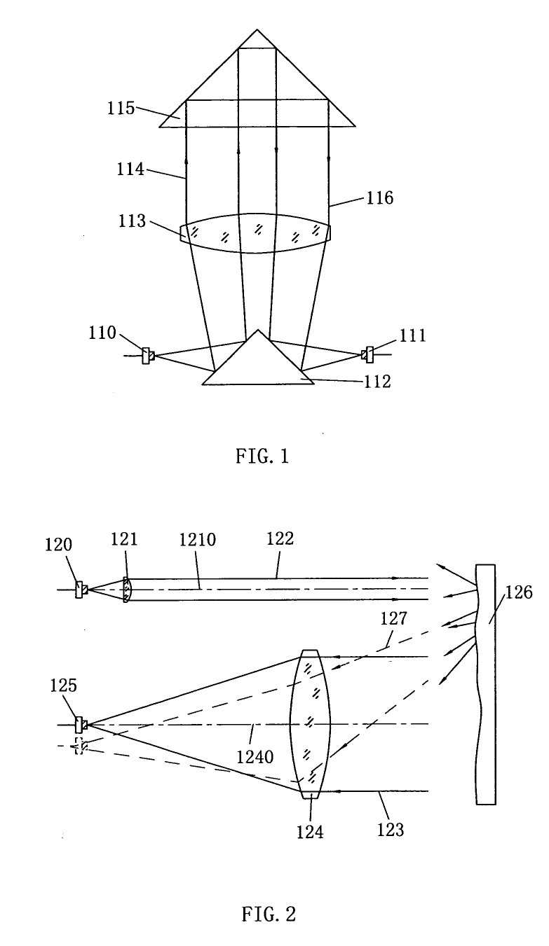

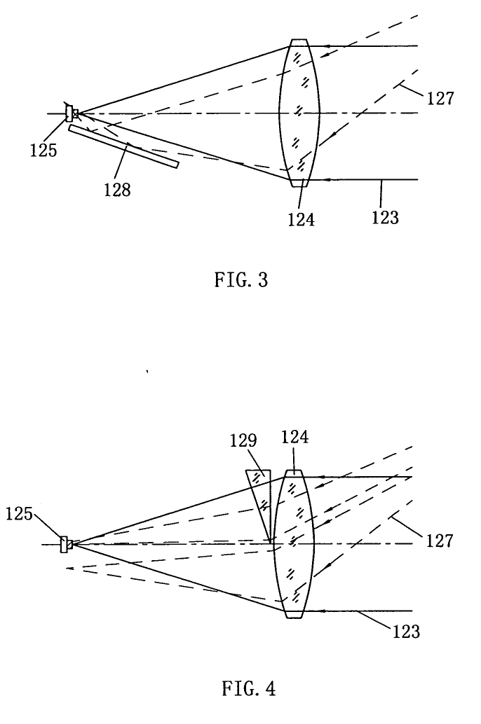

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

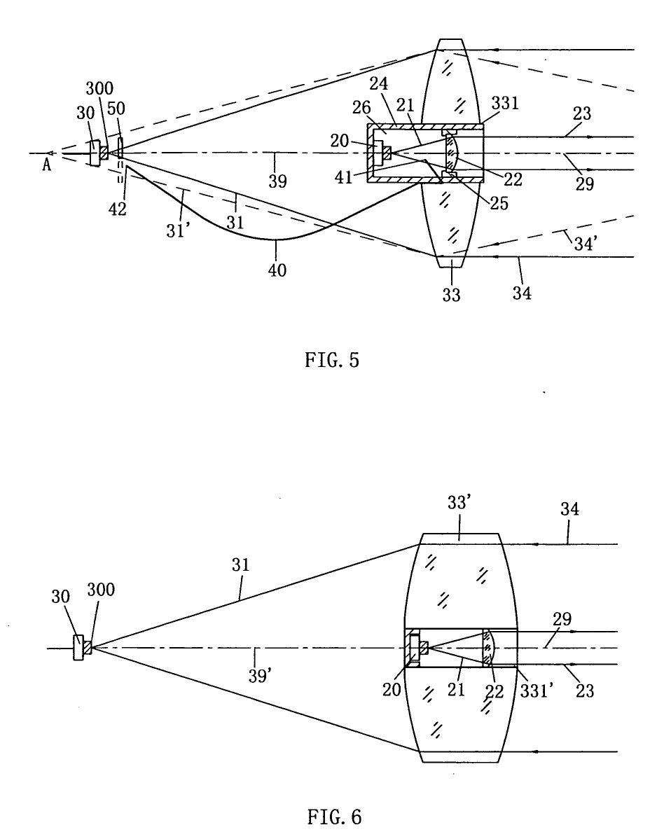

In the first preferred embodiment of the present invention as shown in FIGS. 5 and 6, the distance measuring device comprises an optical beam emitter 20 (e.g., a laser emitter), a collimator objective lens 22, an optoelectronic converter 30, a receiving objective lens 33, and a microprocessor control and analysis system (not shown). The optical beam emitter 20 generates an optical beam 21, which is passed through the collimator objective lens 22 for collimating said the optical beam along the optical axis 29 of the collimator lens 22. From here, the collimated optical beam 23 is projected in a parallel relationship along optical axis 29 to a desired object. The optical beam 23 will be reflected off the desired object and received by the receiving objective lens 33. From here, the beam is directed onto a light receiving surface 300 of the optoelectronic converter 30 and the light beam is converted into a corresponding electrical signal. The microprocessor control and analysis system (not shown) is electrically connected to the optical beam emitter 20 and the optoelectronic converter 30 separately for providing a series of high-frequency signals to modulate said optical beam emitter 20, and analyzing the electrical signals output from said optoelectronic converter 30 to evaluate the measured distance from the measuring device to the desired object.

In a preferred embodiment the microprocessor control and analysis system comprises a modulating circuit for high-frequency modulation of the optical beam emitter 20. As a result, the optical beam emitter 20 generates a high-frequency modulated optical beam for distance measurement. The microprocessor control and analysis system further comprises a signal processing circuit for processing the electrical signals output from said optoelectronic converter 30 to evaluate and display the measured distance from the distance measuring device to the desired object.

Preferably, the optical beam emitter 20 is a laser beam emitter, and more preferably a semiconductor laser diode capable of generating a visible laser beam.

The optoelectronic converter 30 is preferably a single or an array of optoelectronic converting elements, such as PIN photodiode(s) or avalanche photodiode(s), in which the light receiving surface of said optoelectronic converting element(s) acts as said light receiving surface 300 of optoelectronic converter 30. As will be understood by those having skill in the art, the optoelectronic converter 30 may also be comprised of optoelectronic converting element(s) with a light guide (not shown), the light receiving surface of which acts as said light receiving surface 300 of optoelectronic converter 30.

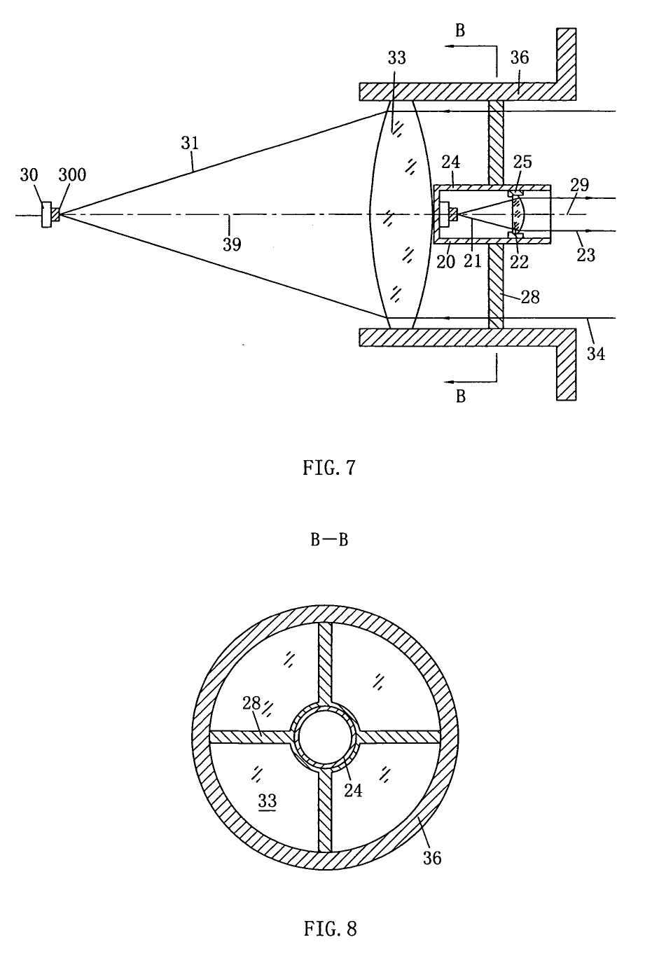

With reference to the preferred embodiments illustrated in FIGS. 5 and 7, the laser emitter 20 and said collimator objective lens 22 are both mounted in a fixing element 24. Fixing element 24 is preferably tube-shaped with a first open end, a second closed end, and a thread portion (not shown) with a predetermined length on its inner surface. The laser emitter 20 lies on the center of the closed end of fixing element 24, capable of generating a laser beam outward through the open end of fixing element 24. The collimator objective lens 22 is fixed in an annular element 25 which has a thread portion (not shown) on its outer surface for engaging with said thread portion of fixing element 24. During assembly, the position of the collimator objective lens 22 can be conveniently adjusted longitudinally along the optical axis 29 of the collimator objective lens 22 with respect to said laser emitter 20 until said laser emitter 20 is positioned in the focal point of said collimator objective lens 22. A laser beam 21 with a certain divergence from said laser emitter 20 is projected through said collimator objective lens 22 to be therefore collimated into a parallel laser beam 23 along said optical axis 29 of collimator objective lens 22.

In the embodiment illustrated in FIG. 5, the receiving objective lens 33 comprises a through aperture 331 extending longitudinally along the optical axis 39 of receiving objective lens 33 for receiving and retaining said fixing element 24. During assembly, the fixing element 24 is adjusted in said aperture 331 until the optical axis 29 of collimator objective lens 22 coincides with the optical axis 39 of receiving objective lens 33, and then is fixed in the aperture 331 preferably with an adhesive. The optoelectronic converter 30 is arranged such that the light receiving surface 300 lies on the optical axis 39 at the focal point of the receiving objective lens 33.

For measuring long distances, the reflected laser beam 34 in the form of a parallel laser beam along optical axis 39 is converged into a converged beam 31 via the receiving objective lens 33. The converged beam 31 is focused on the light receiving surface 300 of optoelectronic converter 30, which is located at the focal point of said receiving objective lens 33. For measuring shorter distances, the reflected laser beam 34′ in the form of a laser beam with a divergence is converged into a converged beam 31′ via the receiving objective lens 33. The converged beam 31′ is focused on a point A behind the focal point of the receiving objective lens 33 on said optical axis 39. However, because the light receiving surface 300 is within the irradiating range of the converged laser beam 31′ the surface 300 can still receive a part of the converged laser beam 31′. When measuring short distances, the converged reflected beam 31′ is so strong that the part of converged beam 31′ received by the light receiving surface 300 is strong enough for the optoelectronic converter 30 to sense the light signals.

If the laser beam 21 from the laser emitter 20 is projected onto the receiving objective lens 33 directly, one part of the laser beam will pass through the receiving objective lens 33 and at the same time another part of the laser beam will be reflected onto the light receiving surface 300 of optoelectronic converter 30. The intensity of the laser beam 21 projected directly onto the receiving objective lens 33 is much greater than that of the converged laser beam 31 or 31′ reflected from the measured object. Further, the stronger laser beam 21 that is projected directly onto the receiving objective lens 33 lays over the converged laser beam 31 or 31′ reflected from the measured object, and as a result the optoelectronic converter 30 cannot function properly. Thus, in order to eliminate this possibility, the fixing element 24 is preferably made of opaque material, or at least one of inner surface and outer surface of said fixing element 24 is covered by a coat of opaque material. In this way, the laser emitter 20 is isolated from said receiving objective lens 33 completely so that said laser beam from said laser emitter 20 cannot be projected onto the receiving objective lens 33 directly. For persons reasonably skilled in the art, it is understandable that said fixing element 24 can be provided with other appropriate structures and/or configured in such a way so that the laser from said laser emitter 20 is not projected onto said receiving objective lens 33 directly.

An external measuring beam path is formed with the laser emitter 20, the collimator objective lens 22, the receiving objective lens 33 and the optoelectronic converter 30.

It is well-known that a known length is measured via an internal reference path, before and after an external length measurement, to compensate for drift effects in the electronics and in the optoelectronic converter for improving the precision of distance measurement. The laser distance measuring device in the present invention further comprises a light guide 40 having a first end 41 that extends into said fixing element 24 before or behind the collimator objective lens 22 for receiving a small part of laser beam from the laser emitter 20 or the collimator objective lens 22. A second end 42 of the light guide 40 extends toward the light receiving surface 300 of the optoelectronic converter 30 for directing the small part of the laser beam thereon. The size of the light receiving area of the first end 41 of light guide 40 is such that the intensity of the small part of the laser beam suits the optoelectronic converter 30. In this manner, an internal measuring beam path is formed.

The laser distance measuring device in the present invention further comprises a switchable beam shelter 50. When the beam shelter 50 is at one position shown with real lines in FIG. 5, the laser beam from the second end 42 of light guide 40 along internal measuring beam path is directed onto the light receiving surface 300 of optoelectronic converter 30. When said beam shelter 50 is at another position shown in FIG. 5 with dashed lines, the converged reflected laser beam 31 or 31′ along external beam measuring path is projected onto the light receiving surface 300 of said optoelectronic converter 30.

In the second preferred embodiment of the present invention as shown in FIG. 6, the laser distance measuring device comprises a receiving objective lens 33′ which is thick enough that the through aperture 331′ in the receiving objective lens 33′ extending along optical axis 39′ is long enough for receiving and housing both the laser emitter 20 and the collimator objective lens 22. In this embodiment, the optical axis 29 of said collimator objective lens 22 at least coincides with optical axis 39′ of said receiving objective lens 33′. The laser emitter 20 lies at the focal point of the collimator objective lens 22. And the optoelectronic converter 30 is arranged so that the light receiving surface 300 lies on optical axis 39 at the focal point of the receiving objective lens 33′. Preferably, the inner surface of the aperture 331′ is covered by a coat of opaque material to prevent the laser bean from the laser emitter 20 from being projected onto said receiving objective lens 33 directly.

Persons reasonable skilled in the art can understand that an aperture with an open end and a closed end can be used instead of said through aperture 331 and 331′ provided in the preferred embodiments as shown in FIG. 5 and FIG. 6. In another embodiment of the present invention, the fixing element 24 with the laser emitter 20 and the collimator objective lens 22 installed therein can further be fixed between the receiving objective lens 33 and the light receiving surface 300 so that the parallel laser beam 23 passes through the through aperture 331 without any laser beam from the laser emitter 20 being projected onto said receiving objective lens 33 directly. In such an arrangement, the shorter the distance between the fixing element 24 and the receiving objective lens 33 and the smaller the diameter of the fixing element 24, the more converged reflected laser beam 31 or 31′ will be.

In another preferred embodiment of the present invention as shown in FIG. 7 and FIG. 8, the receiving objective lens 33 does not comprise an aperture as mentioned above. Instead, the fixing element 24 with the laser emitter 20 and the collimator objective lens 22 installed therein and the light receiving surface 300 of optoelectronic converter 30 lie on opposite sides of the receiving objective lens 33. The optoelectronic converter 30 is so arranged that the light receiving surface 300 lies on optical axis 39 at the focal point of the receiving objective lens 33. The fixing element 24 is so arranged that the laser emitter 20 lies on optical axis 29 at the focal point of the collimator objective lens 22 between the receiving objective lens 33 and the collimator objective lens 22. The receiving objective lens 33 is mounted in a first bracket 36. The fixing element 24 is mounted in a second bracket 28 which comprises an annular portion and several supporting ribbings extending radially from the annular portion. The second bracket 28 is fixed in the first bracket 36. The optical axis 39 of said receiving objective lens 33 coincides with the optical axis 29 of said collimator objective lens 22.

In the preferred embodiments of the laser distance measuring device according to the present invention, the collimator objective lens 22 is circular in shape and has a diameter from about 2 mm to about 4 mm and more preferably from about 4 mm to about 5 mm, and the receiving objective lens 33 is also circular and has a diameter from about 20 mm to 25 mm and more preferably from about 25 mm to about 30 mm. Thus, the ratio of surface area of said collimator objective lens 22 to the surface area of the receiving objective lens 33 is about 1 to about 100, or about 1 to about 36, or anywhere in between. In this regard, the optoelectronic converter 30 can receive enough converged reflected laser beam for proper distance measurement. The dimensions used herein are intended for illuminative purposes only and do not limit the embodiments in any way.

The device according to the present invention can be used to measure short-distances as well as far-distances with the least amount of functional elements. The cost of such a device is therefore low and the device can therefore be configured to be very compact and in particular fit in a pocket of a user.

While the specific embodiments have been illustrated and described, numerous modifications come to mind without significantly departing from the spirit of the invention, and the scope of protection is only limited by the scope of the accompanying Claims.

What is claimed is:

1. A laser distance measuring device, comprising:
a laser emitter for generating a laser beam;
a collimator objective lens for collimating said laser beam;
an optoelectronic converter with a light receiving surface for receiving light signals and converting them into corresponding electrical signals thereof;
a receiving objective lens for receiving and imaging a reflected laser beam from an object to be measured onto said light receiving surface of said optoelectronic converter;
a control and analysis system electrically connected to said laser emitter and said optoelectronic converter for generating a series of high-frequency signals to modulate said laser emitter, and analyzing said electrical signals output from said optoelectronic converter to evaluate a measured distance; and
wherein said collimator objective lens and said receiving objective lens are aligned along a common axis.

2. The laser distance measuring device of claim 1, wherein said laser emitter is arranged on said common axis.

3. The laser distance measuring device of claim 2, wherein said laser emitter is positioned at the focal point of said collimator objective lens.

4. The laser distance measuring device of claim 1, wherein said optoelectronic converter is so arranged that said light receiving surface is located on said common axis.

5. The laser distance measuring device of claim 4, wherein said light receiving surface of said optoelectronic converter is located at the focal point of said receiving objective lens.

6. The laser distance measuring device of claim 1, wherein said receiving objective lens comprises an aperture extending along said common axis.

7. The laser distance measuring device of claim 6, wherein said laser emitter and said collimator objective lens are fixed in said aperture.

8. The distance measuring device of claim 6, wherein said laser emitter and said collimator objective lens are mounted in a fixing element which comprises an inner surface and an outer surface, at least one of which is covered by a coat of opaque material, or said fixing element is made of opaque material.

9. The laser distance measuring device of claim 8, wherein said fixing element is fixed in said aperture of said receiving objective lens.

10. The laser distance measuring device of claim 8, wherein said fixing element is arranged between said light receiving surface and said receiving objective lens, said laser beam from said laser emitter is projected through said collimator objective lens and then passes through said aperture of said receiving objective lens.

11. A laser distance measuring device, comprising:
a laser emitter;
a collimator objective lens;
a receiving objective lens, the receiving objective lens aligned along a common axis with the collimator objective lens;
an optoelectronic converter with a light receiving surface for converting light signals into corresponding electrical signals;
an internal beam path formed between the collimator objective lens and the light receiving surface of the optoelectronic converter; and
a microprocessor for modulating the frequency of the laser emitter and processing the electrical signals of the optoelectronic converter.

12. The laser distance measuring device of claim 11, wherein said laser emitter is positioned at the focal point of said collimator objective lens.

13. The laser distance measuring device of claim 11, wherein said light receiving surface of optoelectronic converter is positioned at the focal point of said receiving objective lens.

14. A distance measuring device comprising:
a laser emitter for projecting a laser beam towards a desired object;
a collimating lens for collimating the laser beam;
a receiving lens for receiving a reflected laser beam from the desired object and directing the reflected laser beam to an optoelectronic converter for converting light signals of the reflected laser beam to corresponding electronic signals;
means for insulating the laser emitter so that the laser beam it projects does not directly contact the receiving lens;
a microprocessor for evaluating the electronic signals and calculating the distance to the desired object; and
wherein the collimating lens and the receiving lens have a common axis.

15. The distance measuring device of claim 14, wherein the collimating lens has a surface area and the receiving lens has a surface area, the ratio between the surface area of the collimating lens and the receiving lens being greater than about 1 to about 100.

16. The distance measuring device of claim 14, wherein the collimating lens, the receiving lens and the optoelectronic converter have a common axis.

17. The distance measuring device of claim 14, wherein the receiving lens has an aperture having at least one opening through which the laser emitter projects the laser beam towards the desired object.

18. The distance measuring device of claim 14 further comprising a switchable laser beam shelter.

19. The distance measuring device of claim 14 further comprising a light guide for directing a part of the laser beam from the laser emitter to the optoelectronic converter.
